(19) United States
(12) Patent Application Publication
(10) Pub. No.: US 2021/0102694 A1
(43) Pub. Date: Apr. 8, 2021

(54) HEAT DISSIPATING UNIT FOR LAMPS, AND LAMPS USING THE SAME

(71) Applicant: SIGNIFY HOLDING B.V., EINDHOVEN (NL)

(72) Inventors: Kaiwang XIE, EINDHOVEN (NL); Zhikai SHI, EINDHOVEN (NL); Liyi ZHU, EINDHOVEN (NL)

(21) Appl. No.: 17/041,000

(22) PCT Filed: Apr. 1, 2019
(86) PCT No.: PCT/EP2019/058181

§ 371 Date: Sep. 24, 2020

(30) Foreign Application Priority Data
Apr. 3, 2018 (CN) PCT/CN2018/081732
May 15, 2018 (EP) 18172273.7

(51) Int. Cl. F21V 29/508; F21V 29/71; F21V 29/85

(52) U.S. Cl. CPC F21V 29/508; F21Y 2115/10; F21V 29/85; F21V 29/713

(57) ABSTRACT

A heat dissipating unit for use in a lamp comprises a frame formed from a thermally conductive plastic, wherein the frame comprises a first interface for contacting lamp driver electronic components and a second interface for contacting an inner surface of a lamp outer housing. This heat dissipating unit provides a direct thermal coupling or bridge between electronic components within a lamp and the lamp outer casing.

### FIELD OF THE INVENTION

This invention relates to the cooling of lamps by using heat dissipating units.

### BACKGROUND OF THE INVENTION

There is a need to assist the passage of heat away from lamps such as LED lamps to prevent overheating. There is accordingly a need for efficient thermal heat dissipation in particular for cooling lamp components to attain better reliability, and prevent early lamp failure induced by high temperatures, such as in components of the driver circuitry.

It is well known to provide a thermal path to a heat sink and/or to an external surface of component. However, there is a need to make this heat transfer as efficient as possible.

WO2014/187335A1 discloses an LED bulb lamp comprises a lampshade, a lamp holder, an LED lamp core, one or more light emitting modules, and an LED driving power supply. The LED lamp core comprises a heat dissipation housing. The heat dissipation housing is manufactured by using a ceramic material or a heat insulation high-polymer composite material and is fixed at a combined portion of the lampshade and the lamp holder. A through hole is formed on a top of the heat dissipation housing or a region close to the top or a region far away from the top. Each light emitting module comprises a base plate and an LED unit formed on the base plate. The base plate is disposed on the top of the heat dissipation housing and/or the region close to the top, so that a heat gradient is formed between the top of the heat dissipation housing and the region far away from the top. The LED driving power supply is located inside the heat dissipation housing or inside the lamp holder and is electrically connected to the light emitting module.

### SUMMARY OF THE INVENTION

The invention is defined by the claims.

According to examples in accordance with an aspect of the invention, there is provided a heat dissipating unit for use in a lamp, comprising:

a frame formed from a thermally conductive plastic, wherein the frame comprises:
a first interface for contacting lamp driver electronic components; and
a second interface for contacting an inner surface of a lamp outer housing.

The term thermally conductive plastic is used to denote a plastic which has been treated to increase its thermal conductivity, so that the thermal conductivity is greater than that for the basic plastic constituent, such as PBT (polybutylene terephthalate) or PC (polycarbonate). This thermal conductivity is approximately 0.2 W/m·K. Thus, the thermal conductivity is larger than 0.3 W/m·K, more preferably larger than 0.5 W/m·K, more preferably larger than 0.8 W/m·K. A greater thermal conductivity comes at an increased cost, so the thermal conductivity is preferably between 0.8 W/m·K and 2.0 W/m·K.

The units W/m·K are W for a power in Watts, m for a dimension in meters and K for a temperature in Kelvin.

The frame is preferably formed as a rigid component, for example injection molded into a desired shape. It has a non-planar, i.e. 3D, shape which provides both an interface to the lamp outer housing and an interface to electronic components.

This heat dissipating unit thus provides a direct thermal coupling or bridge between electronic components within a lamp and the lamp outer casing. This enables a pre-manufactured rigid component to be used instead of requiring potting to create the desired thermal coupling. Thus, the need for curing cycles is avoided, and the unit may be light-weight and low cost. The pre-manufacture enables accurate contact and thermal coupling between the components and the outer casing. The unit also provides protection against vibration and damage by providing an extra fixing of the position of the components relative to the outer casing.

Note that the thermal contact to the heat dissipating unit may be direct or there may be a thin interface layer between the surface of the first and/or second interface and the components or casing. However, the body of the heat dissipating unit has the primary heat transfer function, and any interface layer is solely to ensure continuous contact between the adjacent surfaces.

This design enables lower driver component temperatures to be maintained and thus allows better reliability to be achieved in a lamp which uses the heat dissipating unit.

The thermally conductive plastic for example comprises a PBT (polybutylene terephthalate) or PC (polycarbonate) or ABS (acrylonitrile butadiene styrene) material with a thermally conductive filler. Other plastics are also possible.

The frame may comprise thermally conductive elements which comprise one or more of:

a metal;

a ceramic;

a heat pipe;

a vapor chamber.

These elements may be used to tailor the thermal conductivity to desired levels. Metal or ceramic particles or beads may be embedded in the plastic of the frame. A thermally conductive bonding glue may be used to attach a plastic housing to a heat pipe or vapor chamber.

The first interface for example comprises a set of one or more pads for contacting the surface of one or more lamp driver integrated circuits or electronic components. These pads may be used to provide contact with heat dissipating surfaces of the circuits or components. The components may be passive circuit elements such as capacitors or inductors, or active circuit elements such as a power transistor.

The second interface for example comprises a curved surface. The curved surface is designed to mate with the inner surface of the typically curved outer housing of a lamp. It may for example comprise a portion of the surface of volume of revolution. The lamp outer housing is typically shaped as a volume of revolution.

The first interface may comprise a first interface portion connected to one end of the curved surface and a second interface portion connected to an opposite end of the curved surface.

In this way, the first interface has two parts, for example parallel to each other. This defines a sandwich type structure which can contact components from above and below.

The first interface portion for example comprises pads and the second interface portion comprise pads, wherein the pads of the first and second interface portions face each other. The first interface portion is for example for contacting components on one side of a circuit board and the second interface portion is for contacting components on an opposite side of the circuit board.

Thus, the single heat dissipating unit can be designed to contact key components mounted on a double-sided circuit board, and the first and second interface portions sandwich the circuit board.

The unit may comprise a set of ribs between the first and second interface portions. These ribs enhance the rigidity of the unit.

The second interface preferably comprises a curved surface and the ribs extend radially with respect to the curved surface. The ribs thus strengthen the curved surface.

The first and/or second interface may further comprise a thermal interfacing media. As mentioned above, the plastic body of the heat dissipating unit has the primary heat transfer function, and any interfacing media is primarily to ensure continuous contact between the adjacent surfaces. Thus, the thermal interfacing media is for example less than 1 mm thick.

The invention also provides a lamp driver comprising:

a heat dissipating unit as defined above; and

electronic components which are in contact with the first interface.

The electronic components for example comprise a transformer and one or more integrated circuit chips. The transformer is for example part of a switch mode power supply. The transformer may be on one side of a circuit board and the one or more integrated circuit chips may be on the other side of the circuit board. The heat dissipating unit may be used to transfer heat from a variety of different circuit components.

The invention also provides a lamp comprising:

an outer housing having an outer surface and an inner surface;

a light source; and

a lamp driver as defined above, wherein the second interface of the heat dissipating unit is in contact with the inner surface of the outer housing.

These and other aspects of the invention will be apparent from and elucidated with reference to the embodiment(s) described hereinafter.

### BRIEF DESCRIPTION OF THE DRAWINGS

Examples of the invention will now be described in detail with reference to the accompanying drawings, in which:

FIG. 1 shows a heat dissipating unit;

FIG. 2 shows the heat dissipating unit of FIG. 1 used within a lamp;

FIG. 3 shows the lamp of FIG. 2 with a cross section perpendicular to the length axis; and

FIG. 4 shows the lamp of FIG. 2 with a cross section parallel to the length axis.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a heat dissipating unit for use in a lamp, comprising a frame formed from a thermally conductive plastic, wherein the frame comprises a first interface for contacting lamp driver electronic components and a second interface for contacting an inner surface of a lamp outer housing. This heat dissipating unit provides a direct thermal coupling or bridge between electronic components within a lamp and the lamp outer casing.

As used in the present disclosure, the “lamp driver electronic components” is generally defined with respect to the components mounted on a carrier, for example a printed circuit board (PCB), and does not include the carrier itself. These components provide power supply or rectify the power supplied to the light source(s) of the lamp.

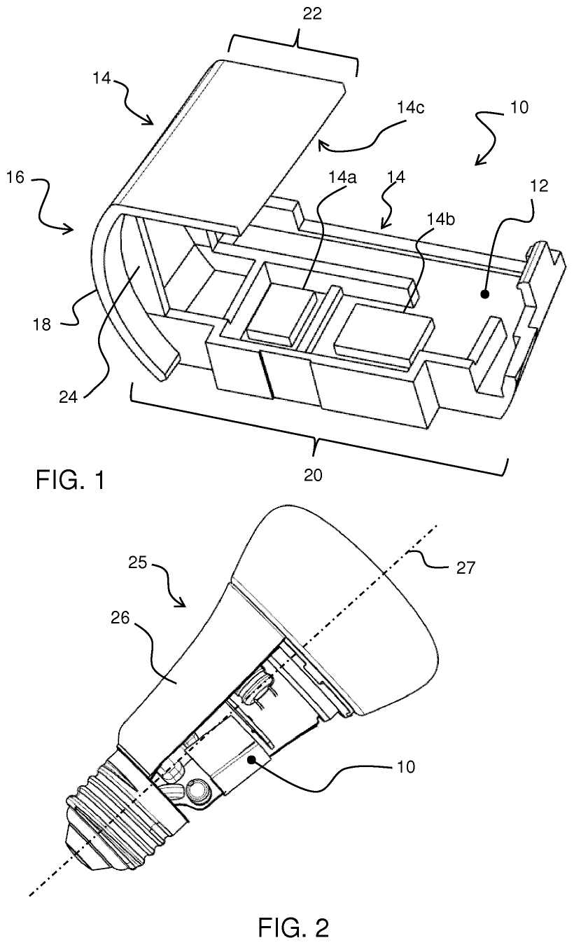

FIG. 1 shows the heat dissipating unit 10, having a frame 12 formed from a thermally conductive plastic.

The thermally conductive plastic has a thermal conductivity which is greater than that of the basic plastic constituent, by incorporating other materials or structures. The thermal conductivity for the basic plastic constituent is for example approximately 0.2 W/m·K. The thermal conductivity of the thermally conductive plastic is preferably larger than 0.3 W/m·K, more preferably larger than 0.5 W/m·K, more preferably larger than 0.8 W/m·K. A greater thermal conductivity comes at an increased cost, so the thermal conductivity is typically between 0.8 W/m·K and 2.0 W/m·K, although higher thermal conductivities may be used if they can be achieved at a suitable cost.

The frame comprises a first interface 14 for contacting lamp driver electronic components. The first interface 14 comprises a set of one or more pads 14a, 14b, 14c for contacting the surface of one or more lamp driver integrated circuits or electronic components. A second interface 16 is for contacting an inner surface of a lamp outer housing. The lamp outer housing is typically shaped as the outer surface of a solid of revolution. The second interface 16 has a corresponding shape to provide an interface fit with the inner surface of the lamp outer housing, and its outer surface is thus shaped as a curved surface 18 which is a portion of the surface a solid of revolution.

In the example shown, the first interface 14 has a first interface portion 20 connected to one end of the curved surface 18 and a second interface portion 22 connected to an opposite end of the curved surface 18.

In this way, the first interface 14 has two parts, for example parallel to each other. This defines a sandwich type structure which can contact components from above and below. The first interface portion has the pads 14a, 14b and the second interface portion 22 has the pad 14c which cannot be seen in FIG. 1, as it is on the underside of the portion 22. The pads of the first and second interface portions thus generally face each other (although they are not necessarily aligned with each other).

The heat dissipation unit may be designed to envelop a circuit board so that the first interface portion 20 is for contacting components on one side of the circuit board and the second interface portion 22 is for contacting components on an opposite side of the circuit board. Thus, the single heat dissipating unit 10 is designed to contact key components mounted on a double-sided circuit board.

The frame is formed as a rigid component, for example injection molded into a desired shape. The heat dissipating unit provides a direct thermal coupling between electronic components within a lamp and the lamp outer casing. This enables a pre-manufactured rigid component to be used instead of requiring potting to create the desired thermal coupling. Thus, the need for curing cycles is avoided, and the unit may be light-weight and low cost. The pre-manufacture enables accurate contact and thermal coupling between the components and the outer casing. The unit also provides protection against vibration and damage by providing an extra fixing of the position of the components relative to the outer casing.

The frame may be formed of any suitable plastics material. Examples are a PBT (polybutylene terephthalate) or a PC (polycarbonate) or an ABS (acrylonitrile butadiene styrene) material, with a thermally conductive filler.

The thermally conductive filler enables the frame to provide a desired heat transfer from the electronic components to the lamp outer housing. The thermally conductive filler may comprise a metal or a ceramic. The filler may be arranged as particles, beads or rods. The thermally conductive material may be an integral embedded part of the frame, but also it may be provided as a separate structure. For example, a heat pipe or a vapor chamber structure may be formed, and a thermally conductive bonding glue may be used to attach a plastic housing to such a heat pipe or vapor chamber.

FIG. 1 also shows a set of ribs 24 between the first and second interface portions 20, 22. These ribs enhance the rigidity of the unit. They extend radially with respect to the curved surface 18.

FIG. 2 shows the heat dissipating unit 10 used within a lamp 25, wherein the lamp has an outer housing 26 which houses a light source, in particular a LED arrangement, and a lamp driver.

The outer housing 26 is shown in partially cut away form to show schematically the internal components of the lamp. The outer housing is rotationally symmetric about an axis of symmetry 27 which corresponds to an optical axis of the lamp. The shape of the outer housing is a solid of revolution about that axis.

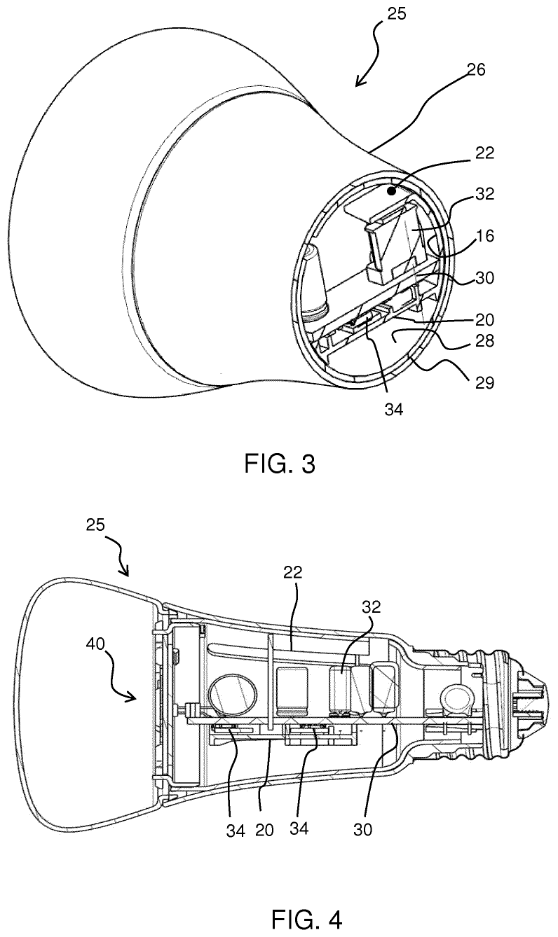

FIG. 3 shows the lamp 25 with a cross section perpendicular to the axis 27. It shows a circuit board 30 having upper and lower faces. A transformer 32 is mounted on the upper face, and the top of the transformer is contacted by the second interface portion 22. The transformer functions as the inductor of an isolated buck converter.

Other components are mounted on the upper and lower face such as an integrated circuit 34. This may be part of the driver electronics, for example a driver IC or it may be an RF communications IC for receiving wireless control commands. Some of the components on the lower face are contacted by the pads 14a, 14b of the first interface portion 20.

The driver may for example comprise a switch mode power supply including a power transistor which functions as a switching device, a driver IC, a rectifier, and an inductor and/or capacitor of the switch mode power supply. As mentioned above, the inductor of the switch mode power supply may be implemented as an isolating transformer. Other components in the lamp may include sensors such as ambient light sensors, presence detectors, and RF communications modules. Some components will be discrete components and others will be part of integrated circuit chips. Depending on the power handling of the various components, thermal dissipation may be important for some or all of the passive components and for some or all of the integrated circuits.

The heat dissipation unit may be designed for any type of lamp driver circuitry. For this reason, a detailed discussion of the lamp driver circuitry is not presented here, and the invention may be applied to any existing lamp circuitry. The list of components set out above is purely by way of example.

The outer inner surface 28 and outer surface 29 of the outer housing 26 are shown. The second interface 16 of the heat dissipating unit is in contact with the inner surface 28 of the outer housing. Thus, the outer shape of the second interface has a shape which matches the shape of the outer housing. It is for example a portion of the surface of a solid of revolution.

FIG. 4 shows the lamp 25 with a cross section parallel to the axis 27. It shows the first and second interface portions 20, 22 between which the circuit board 30 and components 32 (such as a transformer and other discrete passive components) and 34 (such as driver or RF ICs e.g. a buck converter IC) are sandwiched. The LED arrangement is shown as 40.

The heat dissipating unit may be formed as a snap fit onto retaining features of the printed circuit board 30 for ease of assembly. The printed circuit board and attached heat dissipating unit then function as a module which is mounted inside the lamp. The design may achieve both a desired thermal transfer to the lamp outer housing and also good RF performance based on the dielectric properties of the heat dissipating unit.

The heating dissipating unit may have any desired number of contact pads. The heat dissipating unit may directly contact the inner face 28 of the lamp outer housing 26 so that an air gap is prevented, to achieve the best heat conduction. By increasing the thermal transfer efficiency of the lamp system, the driver component temperature is reduced resulting in a longer lamp life, preventing early lamp thermal failure.

The first and/or second interface may however additionally make use of thermal interfacing media. Such an interfacing media may assist in ensuring continuous contact between the adjacent surfaces. The thermal interfacing media is for example less than 1 mm thick.

The heat dissipating unit is designed to provide the required heat transfer. Some components will benefit from contact pads, whereas others will not need direct thermal contact.

The invention is of primary interest for LED lamps although the heat dissipating unit may be used in other lamps.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A heat dissipating unit for use in a lamp, comprising:
a frame formed from a thermally conductive plastic, wherein the frame comprises:
a first interface for contacting lamp driver electronic components; and
a second interface for contacting an inner surface of a lamp outer housing.

2. A heat dissipating unit as claimed in claim 1, wherein the thermally conductive plastic comprises a PBT (polybutylene terephthalate) or PC (polycarbonate) or ABS (acrylonitrile butadiene styrene) material with a thermally conductive filler.

3. A heat dissipating unit as claimed in claim 1, wherein the frame comprises thermally conductive elements which comprise one or more of:
a metal;
a ceramic;
a heat pipe;
a vapor chamber.

4. A heat dissipating unit as claimed in claim 1, wherein the first interface comprises a set of one or more pads for contacting the surface of one or more lamp driver integrated circuits or electronic components.

5. A heat dissipating unit as claimed in claim 1, wherein the second interface comprises a curved surface.

6. A heat dissipating unit as claimed in claim 5, wherein the first interface comprises a first interface portion connected to one end of the curved surface and a second interface portion connected to an opposite end of the curved surface.

7. A heat dissipating unit as claimed in claim 6, wherein the first interface portion comprises pads and the second interface portion comprise pads wherein the pads of the first and second interface portions face each other.

8. A heat dissipating unit as claimed in claim 7, wherein the first interface portion is for contacting components on one side of a circuit board and the second interface portion is for contacting components on an opposite side of the circuit board.

9. A heat dissipating unit as claimed in claim 1, comprising a set of ribs between the first and second interface portions.

10. A heat dissipating unit as claimed in claim 9, wherein the second interface comprises a curved surface and the ribs extend radially with respect to the curved surface.

11. A heat dissipating unit as claimed in claim 1, wherein the first and/or second interface further comprise a thermal interfacing media.

12. A lamp driver comprising:
a heat dissipating unit as claimed in claim 1; and
electronic components which are in contact with the first interface.

13. A lamp driver as claimed in claim 12, wherein the electronic components comprise a transformer and one or more integrated circuit chips.

14. A lamp driver as claimed in claim 13, wherein the transformer is on one side of a circuit board and the one or more integrated circuit chips are on the other side of the circuit board.

15. A lamp comprising:
an outer housing having an outer surface and an inner surfacer;
a light source; and
a lamp driver as claimed in claim 12, wherein the second interface of the heat dissipating unit is in contact with the inner surface of the outer housing.
